(19) United States
(12) Patent Application Publication
(10) Pub. No.: US 2018/0174079 A1
(43) Pub. Date: Jun. 21, 2018

(54) Method, System and Non-Transitory Computer-Readable Recording Medium for Providing Predictions on Reservation

(71) Applicant: Konolabs, Inc., Seoul (KR)

(72) Inventors: Jae Hoon Choi, Seoul (KR); Jung Hee Ryu, Seoul (KR)

(73) Assignee: Konolabs, Inc., Seoul (KR)

(21) Appl. No.: 15/846,536

(22) Filed: Dec. 19, 2017

(30) Foreign Application Priority Data
Dec. 19, 2016 (KR) 10-2016-0173490

(51) Int. Cl. G06Q 10/02; G06Q 50/00; G06Q 30/02

(52) U.S. Cl. CPC G06Q 10/02; G06Q 10/1095; G06Q 30/0254; G06Q 50/01

(57) ABSTRACT

According to one aspect of the invention, there is provided a method for providing a prediction on a reservation, comprising the steps of: predicting a likelihood of occurrence of a no-show in which a user fails to attend a reservation event included in the user's schedule, with reference to information on the reservation event and context information on the user; and dynamically determining notification information to be provided to a device of the user or a device of a counterpart associated with the reservation, on the basis of the likelihood of occurrence of the no-show.

### FIELD OF THE INVENTION

The present invention relates to a method, system and non-transitory computer-readable recording medium for providing predictions on reservations.

### BACKGROUND

In recent years, O2O (Offline-to-Online) services have become widely available, enabling online provision of goods or services that have been provided by locally-based offline stores (so-called local businesses). The O2O services are now provided more frequently through smart devices such as smart phones and tablets.

Particularly, there are many cases where a user uses his/her smart device to make a reservation for specifying the time and location at which services of an offline store (e.g., dinner) are to be provided. Such a reservation may be treated as a kind of event that may be included in the user's schedule, and information on the reservation may be utilized in various ways by calendar applications running on the user's smart device. However, the conventional calendar applications merely provide a simple function of creating an event corresponding to a reservation in the user's calendar.

In this regard, the inventor(s) suggest a technique for predicting a likelihood of occurrence of a no-show in which a user fails to attend a reservation event, with reference to information on the reservation event and context information, and providing the user or the reservation counterpart with various information according to the predicted likelihood of occurrence of the no-show.

### SUMMARY OF THE INVENTION

One object of the present invention is to solve all the above-described problems in the prior art.

Another object of the invention is to predict a likelihood of occurrence of a no-show and provide a user or a reservation counterpart with various information according to the predicted likelihood of occurrence of the no-show, by calculating a likelihood of occurrence of a no-show in which a user fails to attend a reservation event included in the user's schedule, with reference to information on the reservation event and context information on the user, and dynamically determining notification information to be provided to a device of the user or a device of a counterpart associated with the reservation on the basis of the likelihood of occurrence of the no-show.

The representative configurations of the invention to achieve the above objects are described below.

According to one aspect of the invention, there is provided a method for providing a prediction on a reservation, comprising the steps of: predicting a likelihood of occurrence of a no-show in which a user fails to attend a reservation event included in the user's schedule, with reference to information on the reservation event and context information on the user; and dynamically determining notification information to be provided to a device of the user or a device of a counterpart associated with the reservation, on the basis of the likelihood of occurrence of the no-show.

According to another aspect of the invention, there is provided a system for providing a prediction on a reservation, comprising: a prediction unit configured to predict a likelihood of occurrence of a no-show in which a user fails to attend a reservation event included in the user's schedule, with reference to information on the reservation event and context information on the user; and an information provision unit configured to dynamically determine notification information to be provided to a device of the user or a device of a counterpart associated with the reservation, on the basis of the likelihood of occurrence of the no-show.

In addition, there are further provided other methods and systems to implement the invention, as well as non-transitory computer-readable recording media having stored thereon computer programs for executing the methods.

According to the invention, it is possible to predict a likelihood of occurrence of a no-show and provide a user or a reservation counterpart (i.e., a store) with various information according to the predicted likelihood of occurrence of the no-show, so that resources of the reservation counterpart may be minimally wasted due to the user's no-show.

According to the invention, a reservation counterpart (i.e., a store) may proactively recognize a user who habitually causes a no-show.

According to the invention, it is possible to provide a user with a suitable content (e.g., a target advertisement) on the basis of a likelihood of the user causing a no-show.

According to the invention, an application programming interface (API) for predicting a likelihood of occurrence of a no-show may be independently provided, so that various services associated with a no-show may be extensively provided in various types of applications as well as calendar applications.

### BRIEF DESCRIPTION OF THE DRAWINGS

FIG. 1 schematically shows the configuration of an entire system for providing a prediction on a reservation according to one embodiment of the invention.

FIG. 2 illustratively shows the internal configuration of a service provision system according to one embodiment of the invention.

### DETAILED DESCRIPTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the locations or arrangements of individual elements within each of the disclosed embodiments may also be modified without departing from the spirit and scope of the invention. Therefore, the following detailed description is not to be taken in a limiting sense, and the scope of the invention, if properly described, is limited only by the appended claims together with all equivalents thereof. In the drawings, like reference numerals refer to the same or similar functions throughout the several views.

Hereinafter, preferred embodiments of the present invention will be described in detail with reference to the accompanying drawings to enable those skilled in the art to easily implement the invention.

Configuration of the Entire System

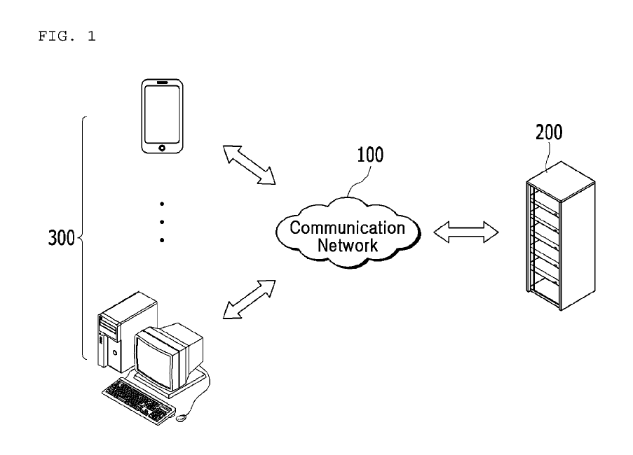

FIG. 1 schematically shows the configuration of an entire system for providing a prediction on a reservation according to one embodiment of the invention.

As shown in FIG. 1, the entire system according to one embodiment of the invention may comprise a communication network 100, a service provision system 200, and a user device (or a reservation counterpart device) 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

Next, the service provision system 200 according to one embodiment of the invention may function to predict a likelihood of occurrence of a no-show and provide a user or a reservation counterpart with various information according to the predicted likelihood of occurrence of the no-show, by calculating a likelihood of occurrence of a no-show in which a user fails to attend a reservation event included in the user's schedule, with reference to information on the reservation event and context information on the user, and dynamically determining notification information to be provided to a device 300 of the user or a device 300 of a counterpart associated with the reservation on the basis of the likelihood of occurrence of the no-show.

Meanwhile, although the service provision system 200 has been described as above, the above description is illustrative, and it will be apparent to those skilled in the art that at least a part of the functions or components required for the service provision system 200 may be implemented or included in the user device (or reservation counterpart device) 300 or an external system (not shown), as necessary.

The configuration and function of the service provision system 200 according to the invention will be discussed in more detail below.

Next, the user device (or reservation counterpart device) 300 according to one embodiment of the invention is digital equipment that may function to allow a user to connect to and then communicate with the service provision system 200, and any type of digital equipment having a memory means and a microprocessor for computing capabilities, such as a smart phone, a tablet, a desktop computer, a notebook computer, a workstation, a personal digital assistant (PDA), a web pad, and a mobile phone, may be adopted as the user device (or reservation counterpart device) 300 according to the invention.

Particularly, the user device 300 may include an application (not shown) to assist a user or reservation counterpart to receive services for no-show predictions from the service provision system 200. The application may be downloaded from the service provision system 200 or a known web server (not shown).

Configuration of the Service Provision System

Hereinafter, the internal configuration of the service provision system 200 crucial for implementing the invention and the functions of the respective components thereof will be discussed.

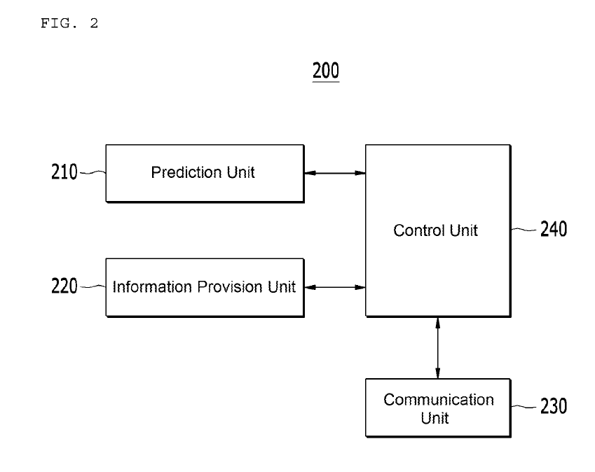

FIG. 2 illustratively shows the internal configuration of the service provision system according to one embodiment of the invention.

Referring to FIG. 2, the service provision system 200 according to one embodiment of the invention may comprise a prediction unit 210, an information provision unit 220, a communication unit 230, and a control unit 240. According to one embodiment of the invention, at least some of the prediction unit 210, the information provision unit 220, the communication unit 230, and the control unit 240 may be program modules to communicate with an external system (not shown). The program modules may be included in the service provision system 200 in the form of operating systems, application program modules, and other program modules, while they may be physically stored in a variety of commonly known storage devices. Further, the program modules may also be stored in a remote storage device that may communicate with the service provision system 200. Meanwhile, such program modules may include, but not limited to, routines, subroutines, programs, objects, components, data structures and the like for performing specific tasks or executing specific abstract data types as will be described below in accordance with the invention.

First, according to one embodiment of the invention, the prediction unit 210 may function to calculate a likelihood of occurrence of a no-show in which a user fails to attend a reservation event included in the user's schedule, with reference to information on the reservation event and context information on the user.

Here, according to one embodiment of the invention, the context information that is referred to in calculating the likelihood of occurrence of a no-show may include information on a current location of the user; information on a current time; information on traffic conditions associated with surroundings or travel routes of the user; information on titles, times, locations, or other attending users of other events in the user's schedule; demographic information of the user; information on the user's activities on a social network service (SNS); information on memos created by the user; information on chats that the user has had with the reservation counterpart; information on a reservation history between the user and the reservation counterpart; and information on a social relationship between the user and the reservation counterpart.

Specifically, according to one embodiment of the invention, the prediction unit 210 may calculate the likelihood of occurrence of a no-show on the basis of an estimated time required to travel from the current location of the user to a location of the reservation event.

Further, according to one embodiment of the invention, the prediction unit 210 may calculate the likelihood of occurrence of a no-show on the basis of an estimated time required to travel between the location of the reservation event and that of another event temporally close to a start time or end time of the reservation event in the user's schedule (e.g., an event existing immediately before or immediately after the reservation event in the user's schedule).

Here, according to one embodiment of the invention, the prediction unit 210 may predict how late the user will be for the reservation event, with reference to the current time and the start time of the reservation event as well as the estimated travel time, and the likelihood of occurrence of a no-show may be calculated to be greater as it is predicted that the user is further late for the reservation event.

More specifically, the prediction unit 210 according to one embodiment of the invention may calculate the likelihood of occurrence of a no-show using a prediction algorithm, which receives information on at least one of the current location of the user; the current time; the location of the reservation event (i.e., the location of the store); the start time of the reservation event; traffic conditions associated with a travel route from the current location of the user to the location of the reservation event; and a location and time of another event temporally close to the reservation event in the user's schedule, and outputs the likelihood of the user causing a no-show.

For example, it may be assumed that a user A is located near Gwanghwamun at the current time of 6:45 pm, and that a reservation event exists in the user's schedule for dinner in a restaurant a located in Cheongdam-dong at 7:00 pm on the same day. In this case, when an estimated time required to travel from the current location of the user A to the location of the restaurant a is 30 minutes (i.e., when the user is expected to be late for the reservation event about 15 minutes), the likelihood of the user causing a no-show may be calculated to be 10%. When an estimated time required to travel from the current location of the user A to the location of the restaurant a is one hour (i.e., when the user is expected to be late for the reservation event about 45 minutes), the likelihood of the user causing a no-show may be calculated to be 50%.

As another example, when a user B is scheduled to stay in Seoul from Dec. 1, 2016 through Dec. 15, 2016, the likelihood of the user causing a no-show for a reservation event for medical treatment in a hospital b located in Gangnam-gu, Seoul on Dec. 3, 2016 may be predicted to be 10%. On the other hand, when the user B is scheduled to stay in the United States from Dec. 16, 2016 through Dec. 31, 2016, the likelihood of the user causing a no-show for a reservation event for medical treatment in the hospital b located in Gangnam-gu, Seoul on Dec. 20, 2016 may be predicted to be 95%.

Meanwhile, various machine learning algorithms using artificial intelligence may be assumed to be the prediction algorithm that may be employed in the invention to predict a likelihood of occurrence of a no-show. However, it is noted that the prediction algorithm is not necessarily limited thereto, and any other type of algorithm may be employed as long as the objects of the invention may be achieved.

Next, according to one embodiment of the invention, the information provision unit 220 may function to dynamically determine notification information to be provided to the device 300 of the user or the device 300 of the reservation counterpart, on the basis of the likelihood of occurrence of a no-show calculated as above. Here, according to one embodiment of the invention, the notification information may include information on a numerical likelihood of the user causing a no-show; information on how late the user will be for the reservation event; information on a reservation history between the user and the reservation counterpart; and information on a frequency of the user causing a no-show.

Specifically, according to one embodiment of the invention, the information provision unit 220 may provide the notification information to the device 300 of the reservation counterpart periodically or aperiodically, before or after the start time of the reservation event.

Further, according to one embodiment of the invention, the information provision unit 220 may function to adaptively determine an advertisement content to be provided to the user device 300, on the basis of the likelihood of occurrence of a no-show. For example, the information provision unit 220 according to one embodiment of the invention may determine a frequency or likelihood of the user receiving an advertisement content associated with the corresponding reservation or reservation counterpart to be higher as the user is less likely to cause a no-show (i.e., as the user is expected to implement the reservation event more faithfully). As another example, in order to lower the user's no-show rate, the information provision unit 220 according to one embodiment of the invention may determine the frequency or likelihood of the user receiving an advertisement content associated with the corresponding reservation or reservation counterpart to be higher as the user is more likely to cause a no-show (i.e., as the user is expected to implement the reservation event less faithfully).

Meanwhile, the communication unit 230 according to one embodiment of the invention may function to enable the service provision system 200 to communicate with an external device such as the user device (or reservation counterpart device) 300.

Lastly, the control unit 240 according to one embodiment of the invention may function to control data flow among the prediction unit 210, the information provision unit 220, and the communication unit 230. That is, the control unit 240 may control inbound data flow or data flow among the respective components of the service provision system 200, such that the prediction unit 210, the information provision unit 220, and the communication unit 230 may carry out their particular functions, respectively.

Although the embodiments for adaptively providing notification information or advertisement contents on the basis of the predicted likelihood of occurrence of a no-show have been mainly described above, it is noted that the present invention is not necessarily limited to the above embodiments, and embodiments for providing the user or reservation counterpart with other types of information or services on the basis of the predicted likelihood of occurrence of a no-show may also be feasible without limitation. According to another embodiment of the invention, the service provision system 200 may independently provide an application programming interface (API) for calculating a likelihood of occurrence of a no-show, thereby assisting another external server or system (not shown) to provide various types of information or services using the API.

The embodiments according to the invention as described above may be implemented in the form of program instructions that can be executed by various computer components, and may be stored on a non-transitory computer-readable recording medium. The non-transitory computer-readable recording medium may include program instructions, data files, data structures and the like, separately or in combination. The program instructions stored on the non-transitory computer-readable recording medium may be specially designed and configured for the present invention, or may also be known and available to those skilled in the computer software field. Examples of the non-transitory computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler or the like, but also high-level language codes that can be executed by a computer using an interpreter or the like. The above hardware devices may be configured to operate as one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

1. A method for providing a prediction on a reservation, comprising the steps of:
predicting a likelihood of occurrence of a no-show in which a user fails to attend a reservation event included in the user's schedule, with reference to information on the reservation event and context information on the user; and
dynamically determining notification information to be provided to a device of the user or a device of a counterpart associated with the reservation, on the basis of the likelihood of occurrence of the no-show.

2. The method of claim 1, wherein the context information includes at least one of information on a current location of the user; information on a current time; information on traffic conditions associated with surroundings or travel routes of the user; information on titles, times, locations, or other attending users of other events in the user's schedule; demographic information of the user; information on the user's activities on a social network service (SNS); information on memos created by the user; information on chats that the user has had with the counterpart; information on a reservation history between the user and the counterpart; and information on a social relationship between the user and the counterpart.

3. The method of claim 1, wherein in the predicting step, the likelihood of occurrence of the no-show is calculated on the basis of an estimated time required to travel from a current location of the user to a location of the reservation event.

4. The method of claim 1, wherein in the predicting step, the likelihood of occurrence of the no-show is calculated on the basis of an estimated time required to travel between a location of the reservation event and a location of another event temporally close to a start time or end time of the reservation event in the user's schedule.

5. The method of claim 3, wherein the predicting step comprises the steps of:
predicting how late the user will be for the reservation event, with reference to the estimated travel time, a current time, and a start time of the reservation event; and
calculating the likelihood of occurrence of the no-show to be greater as it is predicted that the user is further late for the reservation event.

6. The method of claim 1, wherein in the determining step, an advertisement content to be provided to the user is adaptively determined on the basis of the likelihood of occurrence of the no-show.

7. A non-transitory computer-readable recording medium having stored thereon a computer program for executing the method of claim 1.

8. A system for providing a prediction on a reservation, comprising:
a prediction unit configured to predict a likelihood of occurrence of a no-show in which a user fails to attend a reservation event included in the user's schedule, with reference to information on the reservation event and context information on the user; and
an information provision unit configured to dynamically determine notification information to be provided to a device of the user or a device of a counterpart associated with the reservation, on the basis of the likelihood of occurrence of the no-show.

9. The system of claim 8, wherein the context information includes at least one of information on a current location of the user; information on a current time; information on traffic conditions associated with surroundings or travel routes of the user; information on titles, times, locations, or other attending users of other events in the user's schedule; demographic information of the user; information on the user's activities on a social network service (SNS); information on memos created by the user; information on chats that the user has had with the counterpart; information on a reservation history between the user and the counterpart; and information on a social relationship between the user and the counterpart.

10. The system of claim 8, wherein the prediction unit calculates the likelihood of occurrence of the no-show on the basis of an estimated time required to travel from a current location of the user to a location of the reservation event.

11. The system of claim 8, wherein the prediction unit calculates the likelihood of occurrence of the no-show on the basis of an estimated time required to travel between a location of the reservation event and a location of another event temporally close to a start time or end time of the reservation event in the user's schedule.

12. The system of claim 10, wherein the prediction unit predicts how late the user will be for the reservation event, with reference to the estimated travel time, a current time, and a start time of the reservation event, and calculates the likelihood of occurrence of the no-show to be greater as it is predicted that the user is further late for the reservation event.

13. The system of claim 8, wherein the information provision unit adaptively determines an advertisement content to be provided to the user on the basis of the likelihood of occurrence of the no-show.

14. The method of claim 4, wherein the predicting step comprises the steps of:
predicting how late the user will be for the reservation event, with reference to the estimated travel time, a current time, and a start time of the reservation event; and
calculating the likelihood of occurrence of the no-show to be greater as it is predicted that the user is further late for the reservation event.

15. The system of claim 11, wherein the prediction unit predicts how late the user will be for the reservation event, with reference to the estimated travel time, a current time, and a start time of the reservation event, and calculates the likelihood of occurrence of the no-show to be greater as it is predicted that the user is further late for the reservation event.
